(19) United States
(12) Patent Application Publication
(10) Pub. No.: US 2015/0347562 A1
(43) Pub. Date: Dec. 3, 2015

(54) DERIVING USER CHARACTERISTICS FROM USERS' LOG FILES

(71) Applicant: QUALCOMM Incorporated, San Diego, CA (US)

(72) Inventors: Isaac David GUEDALIA, Beit-Shemesh (IL); Sarah GLICKFIELD, St. Louis, MO (US)

(21) Appl. No.: 14/698,638

(22) Filed: Apr. 28, 2015

Related U.S. Application Data
(60) Provisional application No. 62/006,564, filed on Jun. 2, 2014.
(60) Provisional application No. 62/022,068, filed on Jul. 8, 2014.

(51) Int. Cl. G06F 17/30; H04L 29/08

(52) U.S. Cl. CPC G06F 17/30598; H04L 67/10; G06F 17/3012

(57) ABSTRACT

Systems and methods for generating a grammar describing activities of a user are disclosed. An aspect receives log data for the user, clusters the log data around a plurality of cluster centroids, assigns one or more semantic labels to each of the plurality of cluster centroids based on determining that a threshold number of log data points have been assigned to each of the plurality of cluster centroids, determines a sequence in which the log data points were clustered around the plurality of cluster centroids, generates one or more grammars representing a sequence of possible activities of the user based on the sequence in which the log data points were clustered around the plurality of cluster centroids and the one or more semantic labels of each of the plurality of cluster centroids, and filters the assigned one or more semantic labels for each of the plurality of cluster centroids.

### CROSS REFERENCE TO RELATED APPLICATIONS

The present application for patent claims the benefit of U.S. Provisional Application No. 62/006,564, entitled “DERIVING USER CHARACTERISTICS FROM USERS' LOG FILES,” filed Jun. 2, 2014, and U.S. Provisional Application No. 62/022,068, entitled “DERIVING RELATIONSHIPS FROM OVERLAPPING LOCATION DATA,” filed Jul. 8, 2014, assigned to the assignee hereof, and expressly incorporated herein by reference in their entirety.

### INTRODUCTION

Aspects of the disclosure are directed to deriving user characteristics from users' log files.

User devices generally track information related to a user's use of the device, such as the location of the device, battery usage, WiFi access, and/or interactions with other devices (e.g., emails, calls, short message service (SMS) messages, multimedia messaging service (MMS) messages, web browsing history, proximity detections, etc.), and store this information in user log files. User logs reporting on location data, among other data, provides an analysis opportunity that can potentially lend insight into a user's characteristics. For example, is the user more or less social? Does the user spend more time at home or away? How does the user spend his or her leisure time? Is the user athletic, or does he or she enjoy more passive means of recreation? What are the user's hobbies?

### SUMMARY

The following presents a simplified summary relating to one or more aspects and/or embodiments associated with the mechanisms disclosed herein for deriving user characteristics from users' log files. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

A method for generating a grammar describing activities of a user includes receiving log data for the user, the log data representing activities of the user, clustering the log data around a plurality of cluster centroids, wherein each of the plurality of cluster centroids represents an activity of the user, assigning one or more semantic labels to each of the plurality of cluster centroids based on determining that a threshold number of log data points have been assigned to each of the plurality of cluster centroids, determining a sequence in which the log data points were clustered around the plurality of cluster centroids, generating one or more grammars representing a sequence of possible activities of the user based on the sequence in which the log data points were clustered around the plurality of cluster centroids and the one or more semantic labels of each of the plurality of cluster centroids, and filtering the assigned one or more semantic labels for each of the plurality of cluster centroids.

An apparatus for generating a grammar describing activities of a user includes a processor configured to receive log data for the user, the log data representing activities of the user, cluster the log data around a plurality of cluster centroids, each of the plurality of cluster centroids representing an activity of the user, assign one or more semantic labels to each of the plurality of cluster centroids based on a determination that a threshold number of log data points have been assigned to each of the plurality of cluster centroids, determine a sequence in which the log data points were clustered around the plurality of cluster centroids, generate one or more grammars representing a sequence of possible activities of the user based on the sequence in which the log data points were clustered around the plurality of cluster centroids and the one or more semantic labels of each of the plurality of cluster centroids, and filter the one or more semantic labels for each of the plurality of cluster centroids to generate filtered semantic labels.

An apparatus for generating a grammar describing activities of a user includes means for receiving log data for the user, the log data representing activities of the user, means for clustering the log data around a plurality of cluster centroids, wherein each of the plurality of cluster centroids represents an activity of the user, means for assigning one or more semantic labels to each of the plurality of cluster centroids based on determining that a threshold number of log data points have been assigned to each of the plurality of cluster centroids, means for determining a sequence in which the log data points were clustered around the plurality of cluster centroids, means for generating one or more grammars representing a sequence of possible activities of the user based on the sequence in which the log data points were clustered around the plurality of cluster centroids and the one or more semantic labels of each of the plurality of cluster centroids, and means for filtering the one or more semantic labels for each of the plurality of cluster centroids to generate filtered semantic labels.

A non-transitory computer-readable medium for generating a grammar describing activities of a user includes at least one instruction for receiving log data for the user, the log data representing activities of the user, at least one instruction for clustering the log data around a plurality of cluster centroids, wherein each of the plurality of cluster centroids represents an activity of the user, at least one instruction for assigning one or more semantic labels to each of the plurality of cluster centroids based on determining that a threshold number of log data points have been assigned to each of the plurality of cluster centroids, at least one instruction for determining a sequence in which the log data points were clustered around the plurality of cluster centroids, at least one instruction for generating one or more grammars representing a sequence of possible activities of the user based on the sequence in which the log data points were clustered around the plurality of cluster centroids and the one or more semantic labels of each of the plurality of cluster centroids, and at least one instruction for filtering the one or more semantic labels for each of the plurality of cluster centroids to generate filtered semantic labels.

Other objects and advantages associated with the mechanisms disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an aspect of the disclosure.

FIG. 2 is a block diagram illustrating various components of an exemplary user equipment (UE).

FIG. 3 illustrates a communication device that includes logic configured to perform functionality in accordance with an aspect of the disclosure.

FIG. 4 illustrates a server in accordance with an embodiment of the disclosure.

FIGS. 5A-F illustrate an exemplary process for determining relationships between users according to an aspect of the disclosure.

FIG. 6 illustrates an exemplary flow for building a grammar and assigning semantic labels.

FIG. 7 illustrates an exemplary flow for generating a grammar describing activities of a user according to at least one aspect of the disclosure.

FIG. 8 is a simplified block diagram of several sample aspects of an apparatus configured to support communication as taught herein.

### DETAILED DESCRIPTION

The present application for patent is related to the U.S. patent application entitled “DERIVING RELATIONSHIPS FROM OVERLAPPING LOCATION DATA,” having Attorney Docket No. 141142 and filed concurrently herewith, and U.S. application Ser. No. 13/906,169, entitled “A PARALLEL METHOD FOR AGGLOMERATIVE CLUSTERING OF NON-STATIONARY DATA,” filed May 30, 2013, assigned to the assignee hereof, and expressly incorporated herein by reference in their entirety.

The disclosure is related to generating a grammar describing activities of a user. An aspect receives log data for the user, the log data representing activities of the user, clusters the log data around a plurality of cluster centroids, wherein each of the plurality of cluster centroids represents an activity of the user, assigns one or more semantic labels to each of the plurality of cluster centroids based on determining that a threshold number of log data points have been assigned to each of the plurality of cluster centroids, determines a sequence in which the log data points were clustered around the plurality of cluster centroids, generates one or more grammars representing a sequence of possible activities of the user based on the sequence in which the log data points were clustered around the plurality of cluster centroids and the one or more semantic labels of each of the plurality of cluster centroids, and filters the assigned one or more semantic labels for each of the plurality of cluster centroids.

These and other aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

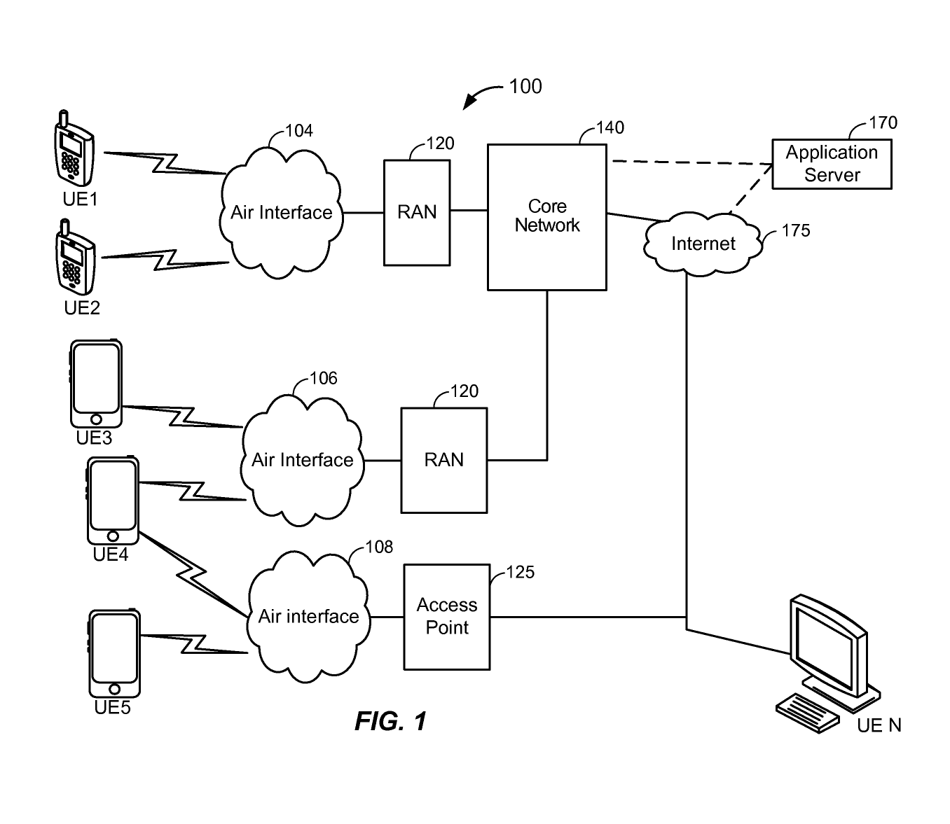

FIG. 1 illustrates a high-level system architecture of a wireless communications system 100 in accordance with an aspect of the disclosure. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or personal computer (PC).

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., Code Division Multiple Access (CDMA), Evolution-Data Optimized (EV-DO), Evolved High Rate Packet Data (eHRPD), Global System of Mobile Communication (GSM), Enhanced Data rates for GSM Evolution (EDGE), Wideband CDMA (W-CDMA), Long-Term Evolution (LTE), etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

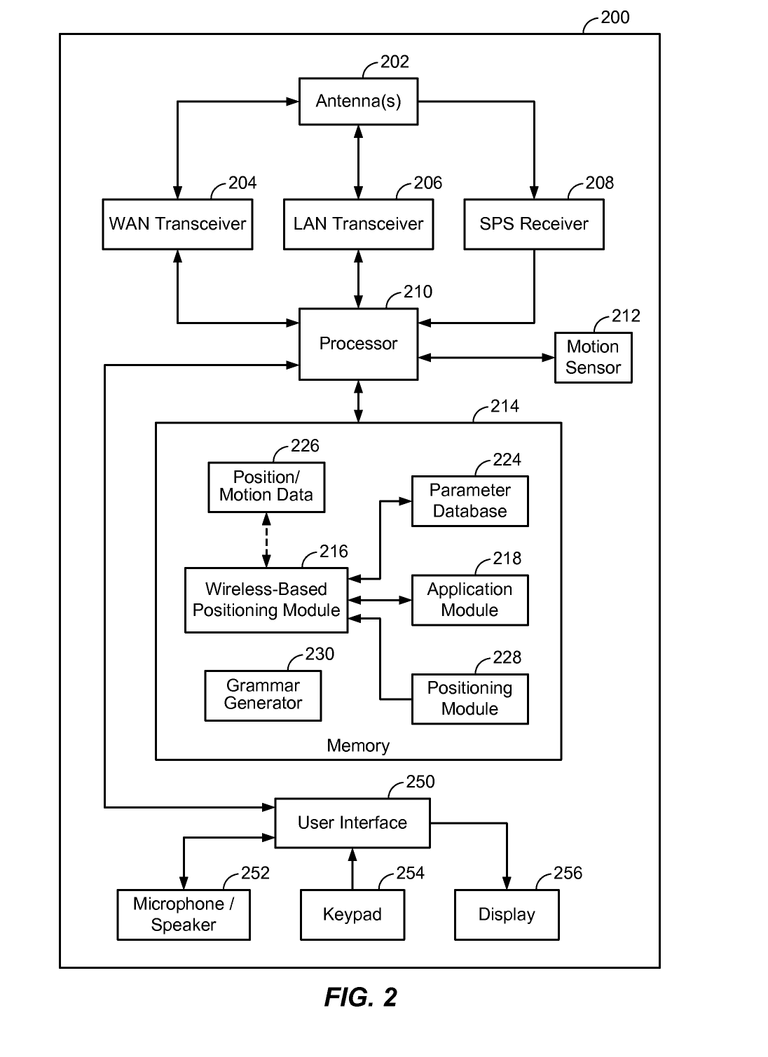

FIG. 2 is a block diagram illustrating various components of an exemplary UE 200. For the sake of simplicity, the various features and functions illustrated in the box diagram of FIG. 2 are connected together using a common bus which is meant to represent that these various features and functions are operatively coupled together. Those skilled in the art will recognize that other connections, mechanisms, features, functions, or the like, may be provided and adapted as necessary to operatively couple and configure an actual portable wireless device. Further, it is also recognized that one or more of the features or functions illustrated in the example of FIG. 2 may be further subdivided or two or more of the features or functions illustrated in FIG. 2 may be combined.

The UE 200 may include one or more wide area network (WAN) transceiver(s) 204 that may be connected to one or more antennas 202. The WAN transceiver 204 comprises suitable devices, hardware, and/or software for communicating with and/or detecting signals to/from WAN-WAPs, such as access point 125, and/or directly with other wireless devices within a network. In one aspect, the WAN transceiver 204 may comprise a CDMA communication system suitable for communicating with a CDMA network of wireless base stations; however in other aspects, the wireless communication system may comprise another type of cellular telephony network, such as, for example, TDMA or GSM. Additionally, any other type of wide area wireless networking technologies may be used, for example, WiMAX (802.16), etc. The UE 200 may also include one or more local area network (LAN) transceivers 206 that may be connected to one or more antennas 202. The LAN transceiver 206 comprises suitable devices, hardware, and/or software for communicating with and/or detecting signals to/from LAN-WAPs, such as access point 125, and/or directly with other wireless devices within a network. In one aspect, the LAN transceiver 206 may comprise a Wi-Fi (802.11x) communication system suitable for communicating with one or more wireless access points; however in other aspects, the LAN transceiver 206 comprise another type of local area network, personal area network, (e.g., Bluetooth). Additionally, any other type of wireless networking technologies may be used, for example, Ultra Wide Band, ZigBee, wireless USB etc.

As used herein, the abbreviated term “wireless access point” (WAP) may be used to refer to LAN-WAPs and/or WAN-WAPs. Specifically, in the description presented below, when the term “WAP” is used, it should be understood that embodiments may include a UE 200 that can exploit signals from a plurality of LAN-WAPs, a plurality of WAN-WAPs, or any combination of the two. The specific type of WAP being utilized by the UE 200 may depend upon the environment of operation. Moreover, the UE 200 may dynamically select between the various types of WAPs in order to arrive at an accurate position solution. In other embodiments, various network elements may operate in a peer-to-peer manner, whereby, for example, the UE 200 may be replaced with the WAP, or vice versa. Other peer-to-peer embodiments may include another UE (not shown) acting in place of one or more WAP.

A satellite positioning system (SPS) receiver 208 may also be included in the UE 200. The SPS receiver 208 may be connected to the one or more antennas 202 for receiving satellite signals. The SPS receiver 208 may comprise any suitable hardware and/or software for receiving and processing SPS signals. The SPS receiver 208 requests information and operations as appropriate from the other systems, and performs the calculations necessary to determine the UE 200's position using measurements obtained by any suitable SPS algorithm.

A motion sensor 212 may be coupled to a processor 210 to provide movement and/or orientation information which is independent of motion data derived from signals received by the WAN transceiver 204, the LAN transceiver 206 and the SPS receiver 208.

By way of example, the motion sensor 212 may utilize an accelerometer (e.g., a microelectromechanical systems (MEMS) device), a gyroscope, a geomagnetic sensor (e.g., a compass), an altimeter (e.g., a barometric pressure altimeter), and/or any other type of movement detection sensor. Moreover, the motion sensor 212 may include a plurality of different types of devices and combine their outputs in order to provide motion information. For example, the motion sensor 212 may use a combination of a multi-axis accelerometer and orientation sensors to provide the ability to compute positions in 2-D and/or 3-D coordinate systems.

The processor 210 may be connected to the WAN transceiver 204, LAN transceiver 206, the SPS receiver 208 and the motion sensor 212. The processor 210 may include one or more microprocessors, microcontrollers, and/or digital signal processors that provide processing functions, as well as other calculation and control functionality. The processor 210 may also include memory 214 for storing data and software instructions for executing programmed functionality within the UE 200. The memory 214 may be on-board the processor 210 (e.g., within the same integrated circuit (IC) package), and/or the memory may be external memory to the processor and functionally coupled over a data bus. The functional details associated with aspects of the disclosure will be discussed in more detail below.

A number of software modules and data tables may reside in memory 214 and be utilized by the processor 210 in order to manage both communications and positioning determination functionality. As illustrated in FIG. 2, memory 214 may include and/or otherwise receive a wireless-based positioning module 216, an application module 218, and a positioning module 228. One should appreciate that the organization of the memory contents as shown in FIG. 2 is merely exemplary, and as such the functionality of the modules and/or data structures may be combined, separated, and/or be structured in different ways depending upon the implementation of the UE 200.

The application module 218 may be a process running on the processor 210 of the UE 200, which requests position information from the wireless-based positioning module 216. Applications typically run within an upper layer of the software architectures. The wireless-based positioning module 216 may derive the position of the UE 200 using information derived from time information measured from signals exchanged with a plurality of WAPs. In order to accurately determine position using time-based techniques, reasonable estimates of time delays, introduced by the processing time of each WAP, may be used to calibrate/adjust the time measurements obtained from the signals. As used herein, these time delays are referred to as “processing delays.”

Calibration to further refine the processing delays of the WAPs may be performed using information obtained by the motion sensor 212. In one embodiment, the motion sensor 212 may directly provide position and/or orientation data to the processor 210, which may be stored in memory 214 in the position/motion data module 226. In other embodiments, the motion sensor 212 may provide data that should be further processed by processor 210 to derive information to perform the calibration. For example, the motion sensor 212 may provide acceleration and/or orientation data (single or multi-axis) which can be processed using positioning module 228 to derive position data for adjusting the processing delays in the wireless-based positioning module 216.

After calibration, the position may then be output to the application module 218 in response to its aforementioned request. In addition, the wireless-based positioning module 216 may utilize a parameter database 224 for exchanging operational parameters. Such parameters may include the determined processing delays for each WAP, the WAPs positions in a common coordinate frame, various parameters associated with the network, initial processing delay estimates, etc.

In other embodiments, the additional information may optionally include auxiliary position and/or motion data which may be determined from other sources besides the motion sensor 212, such as from SPS measurements. The auxiliary position data may be intermittent and/or noisy, but may be useful as another source of independent information for estimating the processing delays of the WAPs depending upon the environment in which the UE 200 is operating.

For example, in some embodiments, data derived from the SPS receiver 208 may supplement the position data supplied by the motion sensor 212 (either directly from the position/motion data module 226 or derived by the positioning module 228). In other embodiments, the position data may be combined with data determined through additional networks using non-RTT techniques (e.g., advanced forward link trilateration (AFLT) within a CDMA network). In certain implementations, the motion sensor 212 and/or the SPS receiver 214 may provide all or part of the auxiliary position/motion data 226 without further processing by the processor 210. In some embodiments, the auxiliary position/motion data 226 may be directly provided by the motion sensor 212 and/or the SPS receiver 208 to the processor 210.

Memory 214 may also include a grammar generator module 230. The grammar generator module 230 may be configured to generate a grammar describing activities of a user as described herein. For example, the grammar generator module 230 may be operable to receive log data for the user, the log data representing activities of the user, cluster the log data around a plurality of cluster centroids, wherein each of the plurality of cluster centroids represents an activity of the user, assign one or more semantic labels to each of the plurality of cluster centroids based on determining that a threshold number of log data points have been assigned to each of the plurality of cluster centroids, determine a sequence in which the log data points were clustered around the plurality of cluster centroids, generate one or more grammars representing a sequence of possible activities of the user based on the sequence in which the log data points were clustered around the plurality of cluster centroids and the one or more semantic labels of each of the plurality of cluster centroids, and filter the assigned one or more semantic labels for each of the plurality of cluster centroids.

While the modules shown in FIG. 2 are illustrated in the example as being contained in the memory 214, it is recognized that in certain implementations such procedures may be provided for or otherwise operatively arranged using other or additional mechanisms. For example, all or part of the wireless-based positioning module 216 and/or the application module 218 may be provided in firmware. Additionally, while in this example the wireless-based positioning module 216 and the application module 218 are illustrated as being separate features, it is recognized, for example, that such procedures may be combined together as one procedure or perhaps with other procedures, or otherwise further divided into a plurality of sub-procedures.

The processor 210 may include any form of logic suitable for performing at least the techniques provided herein. For example, the processor 210 may be operatively configurable based on instructions in the memory 214 to selectively initiate one or more routines that exploit motion data for use in other portions of the UE 200.

The UE 200 may include a user interface 250 that provides any suitable interface systems, such as a microphone/speaker 252, keypad 254, and display 256 that allows user interaction with the UE 200. The microphone/speaker 252 provides for voice communication services using the WAN transceiver 204 and/or the LAN transceiver 206. The keypad 254 comprises any suitable buttons for user input. The display 256 comprises any suitable display, such as a backlit liquid crystal display (LCD), and may further include a touch screen display for additional user input modes.

As used herein, the UE 200 may be any portable or movable device or machine that is configurable to acquire wireless signals transmitted from, and transmit wireless signals to, one or more wireless communication devices or networks. As shown in FIG. 2, the UE 200 is representative of such a portable wireless device. Thus, by way of example but not limitation, the UE 200 may include a radio device, a cellular telephone device, a computing device, a personal communication system (PCS) device, or other like movable wireless communication equipped device, appliance, or machine. The term “user equipment” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “user equipment” is intended to include all devices, including wireless devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above is also considered a “user equipment.”

As used herein, the terms “wireless device,” “mobile station,” “mobile device,” “user equipment,” etc. may refer to any type of wireless communication device which may transfer information over a network and also have position determination and/or navigation functionality. The wireless device may be any cellular mobile terminal, personal communication system (PCS) device, personal navigation device, laptop, personal digital assistant, or any other suitable device capable of receiving and processing network and/or SPS signals.

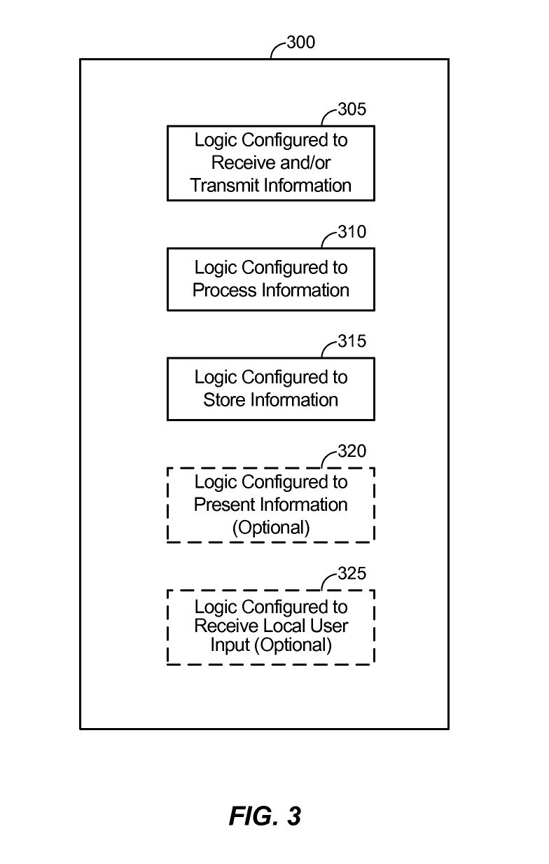

FIG. 3 illustrates a communication device 300 that includes logic configured to perform functionality. The communication device 300 can correspond to any of the above-noted communication devices, including but not limited to UE 200, any component of the RAN 120, any component of the core network 140, any components coupled with the core network 140 and/or the Internet 175 (e.g., the application server 170), and so on. Thus, communication device 300 can correspond to any electronic device that is configured to communicate with (or facilitate communication with) one or more other entities over the wireless communications system 100 of FIG. 1.

Referring to FIG. 3, the communication device 300 includes logic configured to receive and/or transmit information 305. In an example, if the communication device 300 corresponds to a wireless communications device (e.g., UE 200), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., a radio frequency (RF) antenna, a MODEM, a modulator and/or demodulator, etc.). In another example, the logic configured to receive and/or transmit information 305 can correspond to a wired communications interface (e.g., a serial connection, a universal serial bus (USB) or Firewire connection, an Ethernet connection through which the Internet 175 can be accessed, etc.). Thus, if the communication device 300 corresponds to some type of network-based server (e.g., the application server 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include logic configured to receive a stream of data points. The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. The logic configured to process information 310 can include logic configured to receive a stream of data points, logic configured to determine a plurality of cluster centroids, logic configured to divide the plurality of cluster centroids among a plurality of threads and/or processors, logic configured to assign a portion of the stream of data points to each of the plurality of threads and/or processors, and logic configured to combine a plurality of clusters generated by the plurality of threads and/or processors to generate a global universe of clusters. The logic configured to process information 310 can also include logic configured to receive a stream of data points, logic configured to assign a portion of the stream of data points to each of a plurality of threads and/or processors, wherein each of the plurality of threads and/or processors determines one or more cluster centroids and generates one or more clusters around the one or more cluster centroids, and logic configured to combine the one or more clusters from each of the plurality of threads and/or processors to generate a global universe of clusters. The processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, high-definition multimedia interface (HDMI), etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to UE 200 as shown in FIG. 2, the logic configured to present information 320 can include the display 256 and/or the speaker 252. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to UE 200 as shown in FIG. 2, the logic configured to receive local user input 325 can include the microphone 252, the keypad 254, the display 256, etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

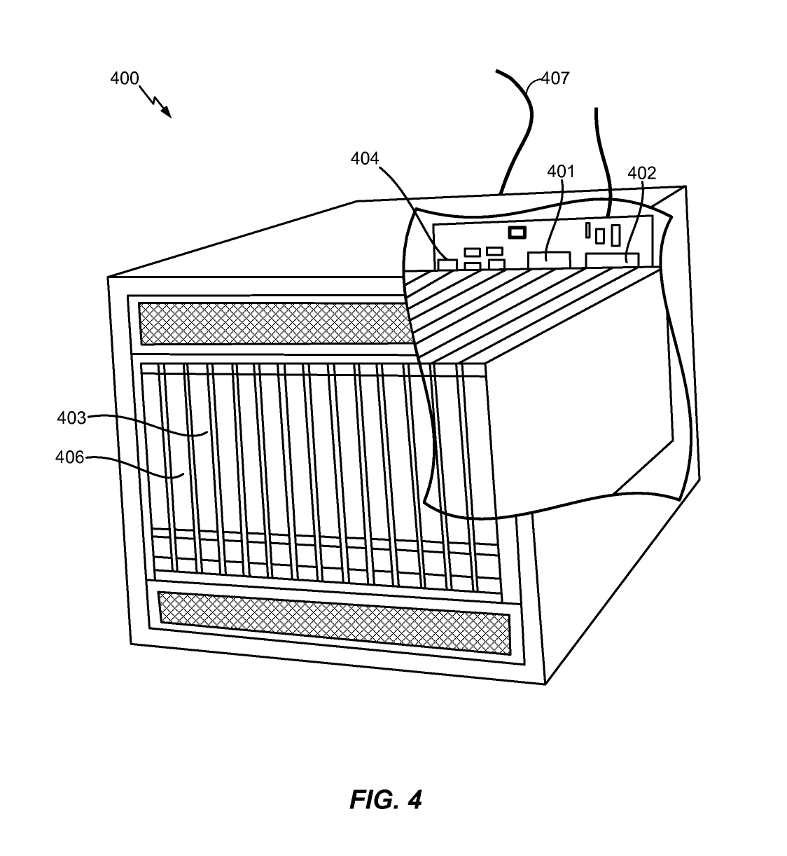

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 400 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access ports 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to a UE implementation as in 200 of FIG. 2.

Further, although not illustrated, the server 400 may include a grammar generator module, similar to the grammar generator module 230 illustrated in FIG. 2. The grammar generator module may be configured to generate a grammar describing activities of a user as described herein. For example, the grammar generator module may be operable to receive log data for the user, the log data representing activities of the user, cluster the log data around a plurality of cluster centroids, wherein each of the plurality of cluster centroids represents an activity of the user, assign one or more semantic labels to each of the plurality of cluster centroids based on determining that a threshold number of log data points have been assigned to each of the plurality of cluster centroids, determine a sequence in which the log data points were clustered around the plurality of cluster centroids, generate one or more grammars representing a sequence of possible activities of the user based on the sequence in which the log data points were clustered around the plurality of cluster centroids and the one or more semantic labels of each of the plurality of cluster centroids, and filter the assigned one or more semantic labels for each of the plurality of cluster centroids.

User devices, such as UE 200 in FIG. 2, generally track information related to a user's use of the device, such as the location of the device, battery usage, WiFi access, and/or interactions with other devices (e.g., emails, calls, SMS messages, MMS messages, web browsing history, proximity detections, etc.), and store this information in user log files. User logs reporting on location data, among other data, provides an analysis opportunity that can potentially lend insight into a user's characteristics. For example, is the user more or less social? Does the user spend more time at home or away? How does the user spend his or her leisure time? Is the user athletic, or does he or she enjoy more passive means of recreation? What are the user's hobbies?

The present disclosure leverages location data to learn about users' relationships and their behavior. Given the location data, such as global positioning system (GPS) coordinates or serving cell identifier, the first step is to discover the significant places, which can be accomplished using a clustering algorithm. Once the significant places have been identified, the proposed system determines how users transition from location to location, which can be used to identify relationships between users.

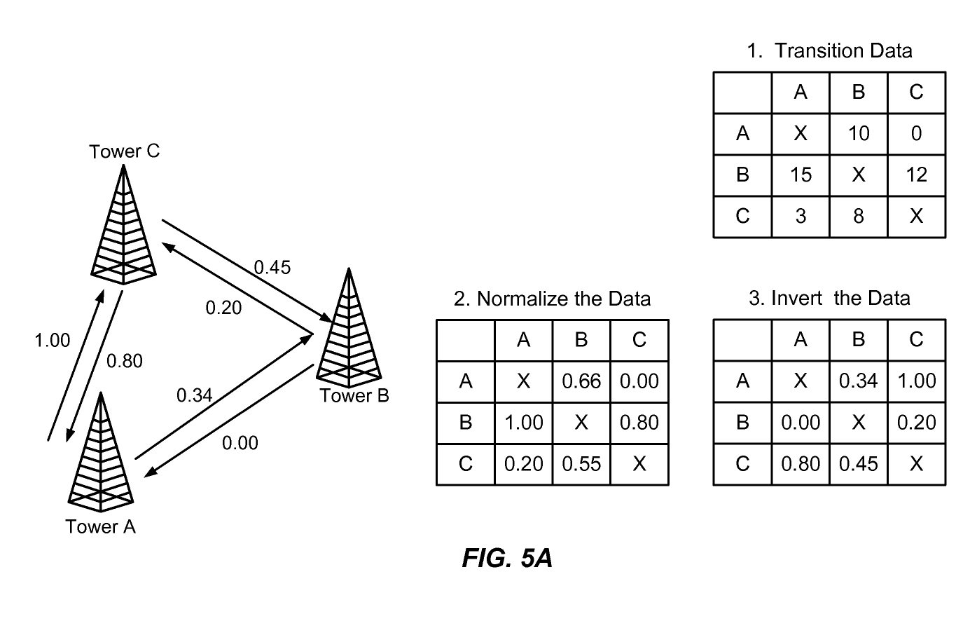

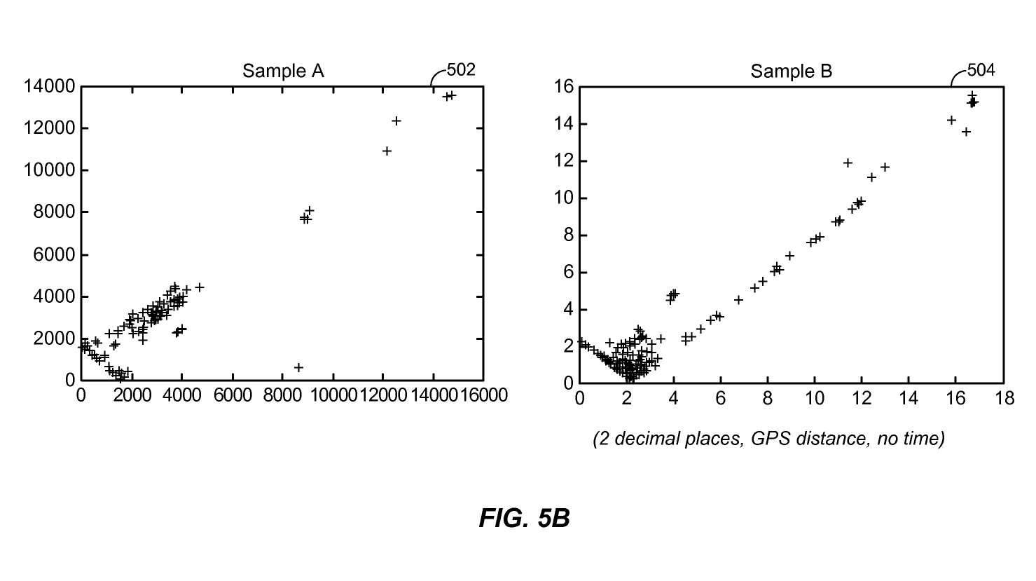

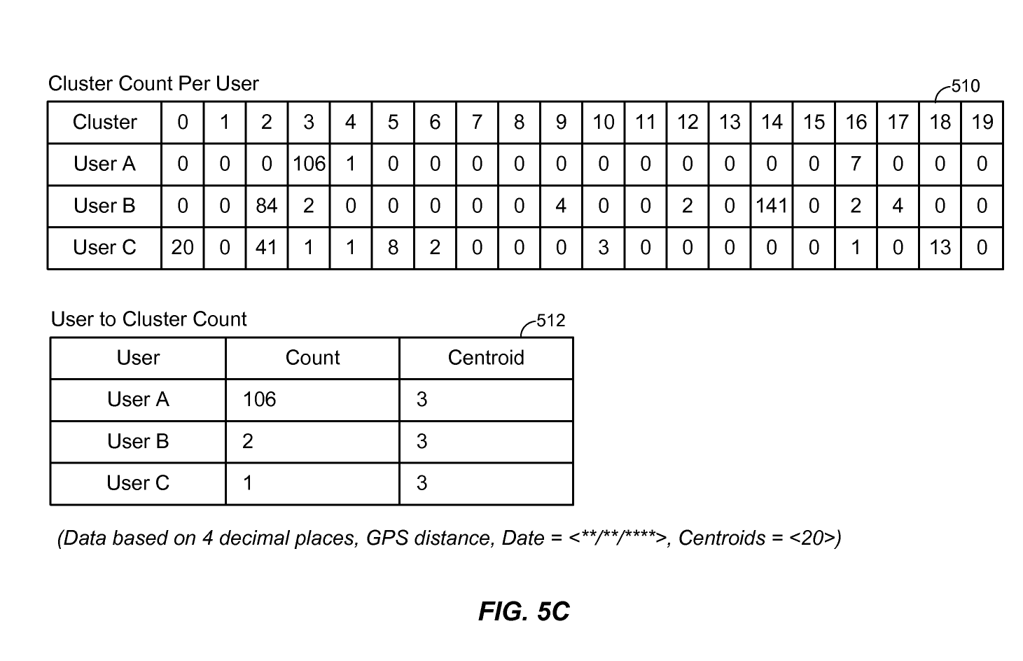

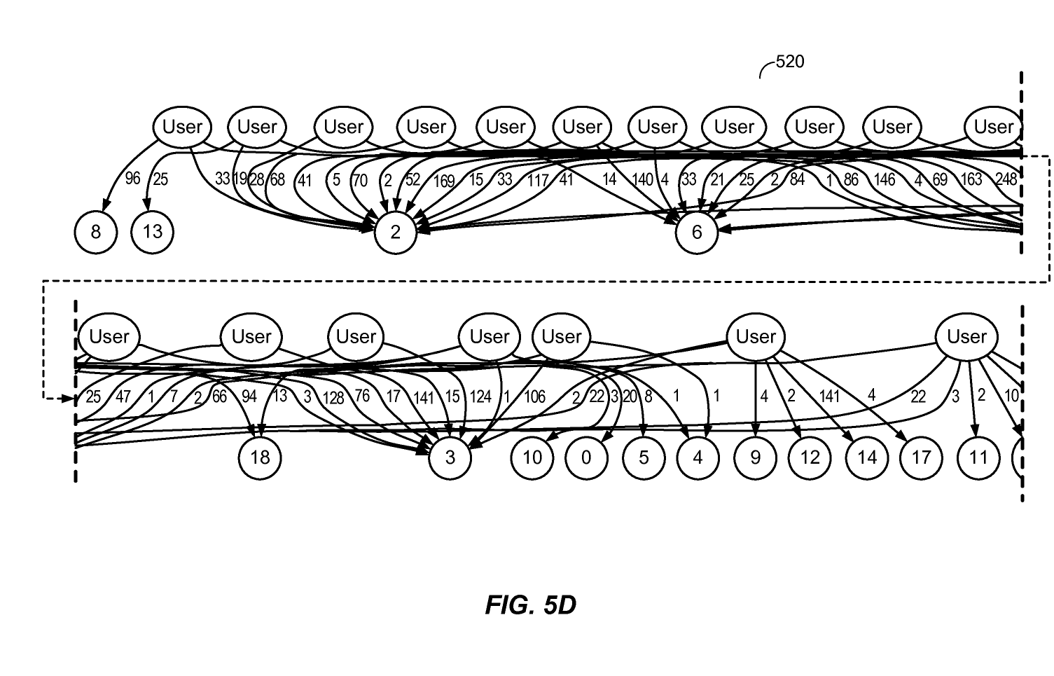

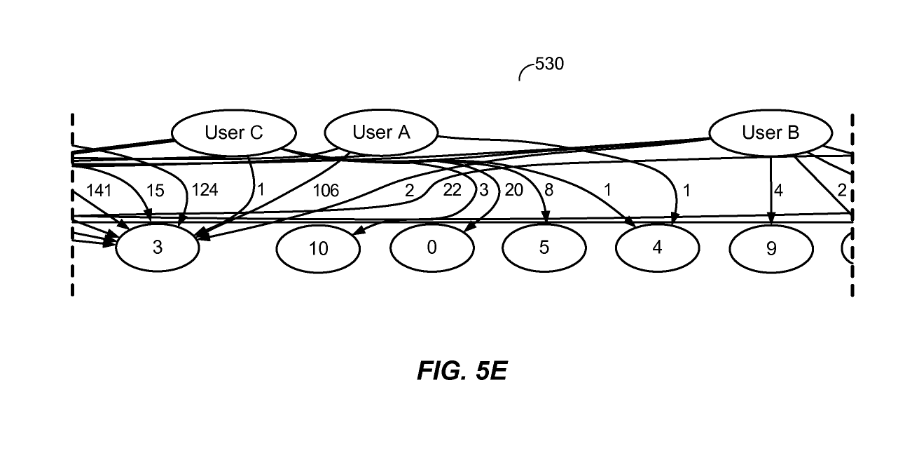

FIGS. 5A-F illustrate an exemplary process for determining relationships between users according to an aspect of the disclosure. The initial step is to extract the values from the log data that the system will cluster. For example, the log data for the user's location at a particular time can be clustered. Location distance can be measured either using geographic distance, e.g., GPS distance as determined by wireless-based positioning module 216, or using transition distances.

The geographic distance is measured by using the GPS coordinates stored with the log data. In contrast, the transition distance represents the number of times a device transitions from one location to another. FIG. 5A illustrates an example of determining transition distances. In the example of FIG. 5A, the user's location data includes the serving cell identifier of three cells/base stations, i.e., Tower A, Tower B, and Tower C, to which the user's device has been attached over some period of time. The transition distance is determined by measuring the number of times the device transitions from one location (e.g., serving cell) to another (shown in Table 1 of FIG. 5A).

Transitions that occur more frequently indicate a shorter distance between two locations, whereas transitions that occur less frequently indicate a greater distance between two locations. In the example of FIG. 5A, Towers A and C are closest together, as indicated by the transition distances 1.00 (A to C) and 0.80 (C to A).

Next, the extracted data, e.g., the user's location data, is clustered. FIG. 5B illustrates two sets of data points (Sample A 502 and Sample B 504) representing the user's locations that have been clustered.

For each user, the system then identifies to which cluster(s) their location data belongs. FIG. 5C illustrates two tables 510 and 512 representing the cluster count per user and the user to cluster count. As shown in the cluster count per user table 510, User A was at the locations corresponding to clusters 3, 4, and 7 106, 1, and 7 times, respectively. As can be seen in the cluster count per user table 510, and as shown in the user to cluster count table 512, each user was at the location corresponding to cluster 3 at some point in time. Depending on the implementation, the point in time may be a common point in time, e.g., the same hour, the same day, the same week, etc., but it need not be.

Next, as illustrated in FIG. 5D, the system builds a graph 520 representing a mapping between the users and the clusters to which each user belongs. To determine the relationships between users, the system can identify which users share clusters. FIG. 5E illustrates a graph 530 for the Users A, B, and C shown in FIG. 5C. As illustrated in FIG. 5C and as shown in FIG. 5E, Users A, B, and C have cluster “3” in common, and are thus related via cluster “3.” As such, it can be inferred that there is some relationship between Users A, B, and C.

Over time, the cluster numbers can be replaced with semantic labels, as illustrated by graph 540 in FIG. 5F. To do so, the system generates a grammar describing patterns of user behavior. Once there are enough data points around a given centroid (which may represent a particular location), the system looks up possible semantic labels for the centroid. For example, a particular centroid may be associated with the labels “Starbucks,” “coffee shop,” “breakfast,” “work” (as in the user's place of employment), etc. The system then analyzes the sequence in which the data points were clustered around the various centroids using, for example, the SEQUITUR algorithm. Over time, as patterns emerge in the grammar, the system can determine what a particular location means to the user and assign one of the possible semantic labels accordingly.

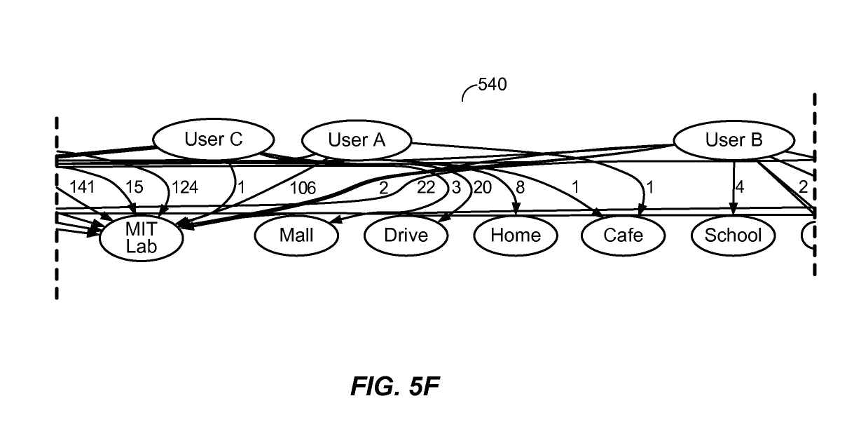

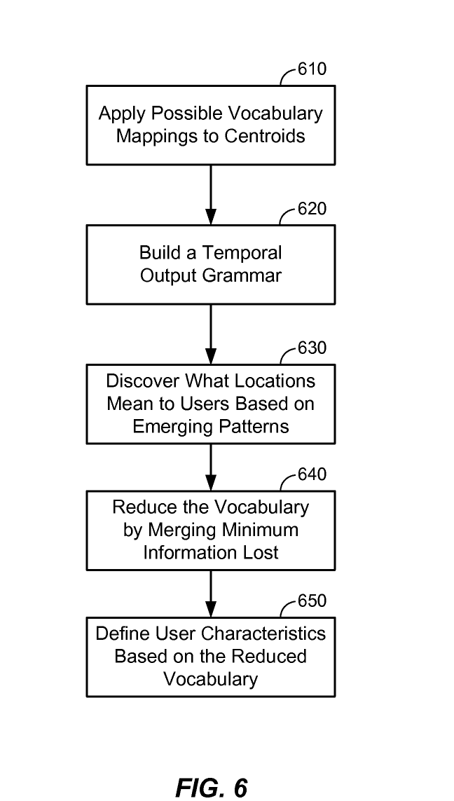

FIG. 6 illustrates an exemplary flow for building this grammar and assigning semantic labels. The flow illustrated in FIG. 6 begins after the clustering and graphing illustrated in FIGS. 5A-E and results in the semantically labeled graph illustrated in FIG. 5F. The flow illustrated in FIG. 6 may be performed entirely by a user device, or by a server that receives the collected user data from the user device, or by a combination of the user device and the server. As used herein, the term “system” refers to the user device, the server, or both the user device and the server.

At 610, the system applies all possible vocabulary mappings, or labels, to the identified centroids. Referring to the above example, if a particular centroid is associated with the location of a Starbucks, the system may assign the vocabulary mappings, or labels, “Starbucks,” “coffee shop,” “breakfast,” “lunch,” “work,” “hotspot,” etc. to the centroid.

At 620, the system builds a temporal output grammar. Specifically, the system identifies the sequence that the user transitions from location (represented as a centroid) to location using, e.g., the SEQUITUR algorithm. For example, the user may transition from centroids/locations A to B to C to A one day, and from centroids/locations A to D to C to A another day. The names “A,” “B,” “C,” and “D” are simply generic labels for the centroids at this point, although each centroid may be associated with a list of possible labels from 610. Alternatively, 620 can be performed before 610.

Over time, the system can discover what particular locations mean to users (i.e., the underlying semantic meaning) based on patterns that emerge in the grammar (630). For example, centroids A-D may have been assigned the following vocabularies/labels:

A=home, eat, sleep, play, read

B=Starbucks, work, eat, coffee, Wi-Fi

C=work, meetings, shopping

D=IHOP, eat, work, meet

If the pattern of transitions for a first day is A, B, C, A (i.e., the user transitioned from locations/centroids A to B to C to A), then the system generates all possible grammars for that day (each row represents a possible grammar):

[home], [eat], [work], [home]

[sleep], [Wi-Fi], [work], [eat]

[home], [coffee], [work], [home]

[home], [work], [work], [home]

. . .

The system does the same for a second day, where the pattern may be A, D, C, A (i.e., the user transitioned from locations/centroids A to D to C to A). Again, each row represents a possible grammar:

[home], [eat], [work], [home]

[sleep], [work], [work], [eat]

[home], [meet], [work], [home]

. . .

Over time (e.g., days, weeks, months, etc.), if the user transitions from A to B to C and A to D to C enough times, the system can learn that B and D are similar. Since one is an IHOP (D) and the other is a Starbucks (B) but both are also labeled “eat” and appear in the grammar in the same way, i.e., between centroids/locations A and C, or “home” and “work,” the system can infer that the proper semantic label is likely “eat.”

Once semantic labels have been assigned to a certain pattern of centroids/locations, the system can use existing patterns to label new patterns that emerge. For example, assume that the user has a pattern of transitioning from centroids/locations A to B to C to A, where A is “home,” B is “eat,” and C is “work.” If, however, beginning at a new centroid location X, the same pattern emerges, i.e., the user transitions from centroids/locations X to Y to Z to X, it may be inferred that X is similar to A, Y is similar to B, and Z is similar to C. In this example, X may be a hotel, Y may be a Dunkin' Donuts, and Z may be a different office location for the user's work. In this case, the system may assign the semantic label “eat” to the centroid/location Y and the semantic label “work” to the centroid/location Z. The system may also be able to assign the semantic label “hotel” to the centroid/location X, rather than the label “Marriott,” for example, based on its correspondence to the centroid/location A, or “home.”

Adding temporal analysis to the pattern identification will yield improved results. For example, if the user is at centroids/locations B and D at approximately the same time on different days, the system can infer that B and D are similar, as in the above, where B and D are both places the user can “eat.”

At 640, the system reduces the vocabulary by merging minimum information lost. The vocabulary mappings assigned in 610, and even the semantic labels determined in 630, may include overlapping terms that can be reduced to a single term. For example, the terms “car,” “vehicle,” “automobile,” and “home,” “house,” “residence” could be reduced to a single term while keeping essentially the same meaning.

Information can be converted into meaning; adding meaning into the system decreases the amount of information. This is not only an inverse relationship however; rather, information and meaning are coupled. An uncoupled relationship means that meaning can be added without removing information. A coupled relationship means that adding meaning must decrease information.

Grammars allow for syntagmatic analysis of text, which is multi-dimensional. The present disclosure proposes adding in grammar analysis to help identify where best to replace words. This has the following benefits: (a) accuracy, i.e., minimizing information loss, (b) performing analysis at the grammar level, which is on the order of log N, rather than on the matrix, which is the order of N×M, and (c) approaching the text subjective to the specific document involved.

There may be a number of meanings in a text, which the present disclosure refers to as “Ecos.” By identifying the minimum loss of information, the system can consequently identify the minimum addition of meaning. Specifically, given a text, there are two ways of interpreting it: remove all information and substitute it with meaning, or increase the amount of information until there is only one Eco left.

Referring to removing all information, given the amount of information in a text, there are “X” Ecos. The system then chooses one of the Ecos. This option is not optimal, however, as it requires direct interpretation and input.

Referring to increasing the amount of information until there is only one Eco left, given a text, information can be measured. The system can statistically and grammatically analyze the text and determine a new representation that is much denser (i.e., proportionally, the new interpretation contains more information). The system takes the compressed, high information text and asks how many Ecos (e.g., meanings/interpretations) are there? The system can add meaning by analyzing the grammar rules of the compressed text, identifying subsets that have even more information, and removing the redundancies.

The system attempts to identify the smallest subset of texts that has the highest information in it. It can do so by removing text without removing information, thereby increasing the density of the information. It can also choose rules that are most similar, thus collapsing the text with the minimum information loss. It can also find the grammar with the fewest rule overlaps, such as the phrases “He rode his bike” and “He rode his bicycle,” and find a point of convergence for the two.

In the syntagmatic approach, grammar analysis can be leveraged to derive contextual information and merge such that there is the least loss of information. This can be accomplished by creating a grammar and analyzing the rules of that grammar. The system finds the rules that carry the least amount of information. In particular, the system can find two rules that will change the least content that will least change the meaning, as demonstrated in the third approach below.

The following illustrates a first approach, in which both “X” and “Y” are changed to “Z”:

0=cXg→0=cZg

1=cYg→1=cZg

2=aXb→2=aZb

3=aYb→3=aZb

The result is that two terminals are changed and four rules are compressed into two.

The following illustrates a second approach, in which “X,” “Y,” “P,” and “Q” are changed to “Z”:

0=cXg→0=cZg

1=cYg→1=cZg

2=cPg→2=cZg

3=cQg→3=cZg

In this case, four non-terminals have been changed and four rules are compressed into one.

The following illustrates the third approach, in which “Y” is changed to “Z”:

0=cYz→0=cZg

1=cYg→1=cZg

The result of this approach is that two non-terminals are changed and two rules are compressed into one.

In determining where to remove information and add meaning, it is necessary to discover the minimum amount of information removal. As discussed above, adding in grammar analysis to help identify where best to replace words has the following benefits: (a) accuracy, i.e., minimizing information loss, (b) performing analysis at the grammar level, which is on the order of log N, rather than on the matrix, which is the order of N×M, and (c) approaching the text subjective to the specific document involved

Referring back to FIG. 6, as will be appreciated, since the processing performed at 640 of FIG. 6 operates on multiple terms, 640 can be performed before or in conjunction with 630. That is, the above-described vocabulary reduction by merging minimum information lost can be performed before or in conjunction with the identification and assignment of semantic labels in 630.

Referring to FIG. 6, at 650, the system can define user characteristics based on the new vocabulary. In the above example, the system could determine that the user has a daytime job, that the user goes to work at approximately the same time on work days, that the user eats breakfast away from home on work days, that the user eats lunch at work on work days, that the user does not eat dinner away from home on work days, etc.

In addition, the system can compare one user's grammar with another user's grammar to determine information about the users and/or to assign the correct semantic label to a centroid/location. Using the above example, if a first user transitions between the centroids/locations A, B, C, and D and a second user transitions between the centroids E, B, E, where B represents a Starbucks, the system can infer that the first user is eating, or getting coffee, at Starbucks, while the other user works there.

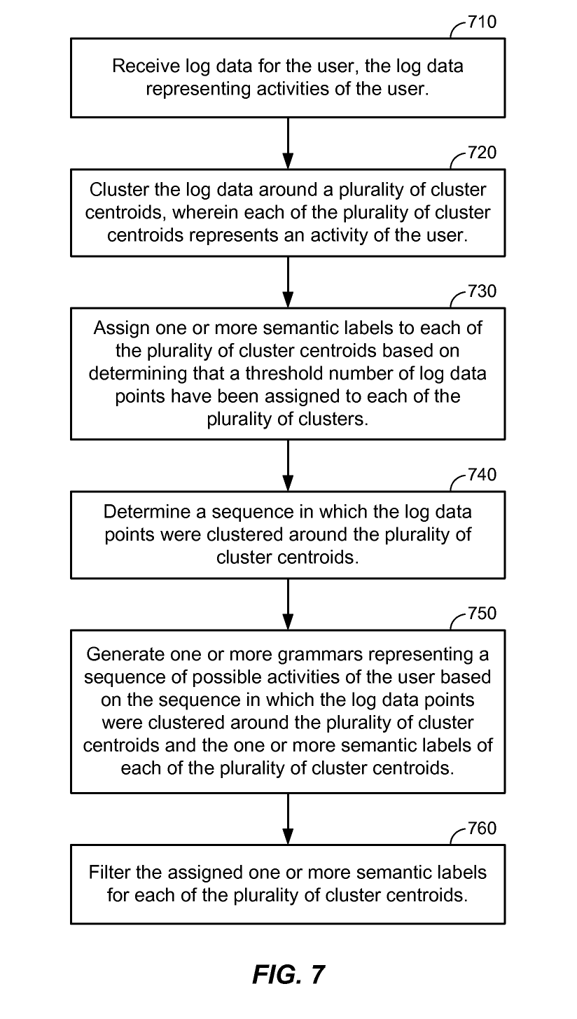

FIG. 7 illustrates an exemplary flow for generating a grammar describing activities of a user according to at least one aspect of the disclosure. The flow illustrated in FIG. 7 may be performed entirely by a user device, or by a server that receives the collected user data from the user device, or by a combination of the user device and the server.

At 710, the user device or the server receives log data for the user. If the user device is receiving the log data, it may be retrieving the log data from its local memory, receiving it in real time as it is recorded, or receiving it from a peer device, for example. If the server is receiving the log data, it may be receiving the log data from the user device.

The log data may represent activities of the user. In an aspect, the log data may include GPS coordinates of the user, phone calls, SMS/MMS messages, and/or emails made and/or received by the user, access to local wireless networks by the user, and/or Internet browsing history of the user, for example. An activity of the user may be a location of the user, a phone call, SMS/MMS message, and/or email sent to and/or received by the user from a particular contact, an access to a local wireless network by the user, and/or an access to a website, for example.

At 720, the user device or the server clusters the log data around a plurality of cluster centroids. Each of the plurality of cluster centroids may represent an activity of the user.

At 730, the user device or the server assigns one or more semantic labels to each of the plurality of cluster centroids based on determining that a threshold number of log data points have been assigned to each of the plurality of cluster centroids.

At 740, the user device or the server determines a sequence in which the log data points were clustered around the plurality of cluster centroids.

At 750, the user device or the server generates one or more grammars representing a sequence of possible activities of the user based on the sequence in which the log data points were clustered around the plurality of cluster centroids and the one or more semantic labels of each of the plurality of cluster centroids. The one or more grammars may represent permutations of the one or more semantic labels for each of the plurality of cluster centroids and the sequence in which the log data points were assigned to the plurality of cluster centroids. In an aspect, the one or more grammars may be generated based on log data received over a period of days.

In an aspect, generating the one or more grammars may include identifying one or more patterns in the sequence in which the log data points were clustered around the plurality of cluster centroids. Each of the one or more patterns may include a series of cluster centroids of the plurality of cluster centroids. The user device or the server can then assign one of the corresponding one or more semantic labels to each cluster centroid in the identified one or more patterns.

At 760, the user device or the server filters the assigned one or more semantic labels for each of the plurality of cluster centroids. In an aspect, the filtering may include comparing a pattern identified in a first grammar of the one or more grammars to a pattern identified in a second grammar of the one or more grammars, and removing one or more semantic labels from the assigned one or more semantic labels based on identifying an overlapping or similar pattern in the first grammar and the second grammar.

In another aspect, the filtering may include comparing a pattern identified in a first grammar of the one or more grammars to a pattern identified in a second grammar of the one or more grammars, and assigning a semantic label to at least one cluster centroid in the pattern identified in the second grammar based on a similarity between the first grammar and the second grammar.

Although not illustrated in FIG. 7, the user device or the server can transmit the generated grammar, the semantic labels, or the filtered results to another entity. For example, where a user device is performing the flow illustrated in FIG. 7, the user device can send the generated grammar, the semantic labels, and/or the filtered results to the server or one or more other user devices. Similarly, where a server is performing the flow illustrated in FIG. 7, the server can send the generated grammar, the semantic labels, and/or the filtered results to one or more other servers or one or more other user devices.

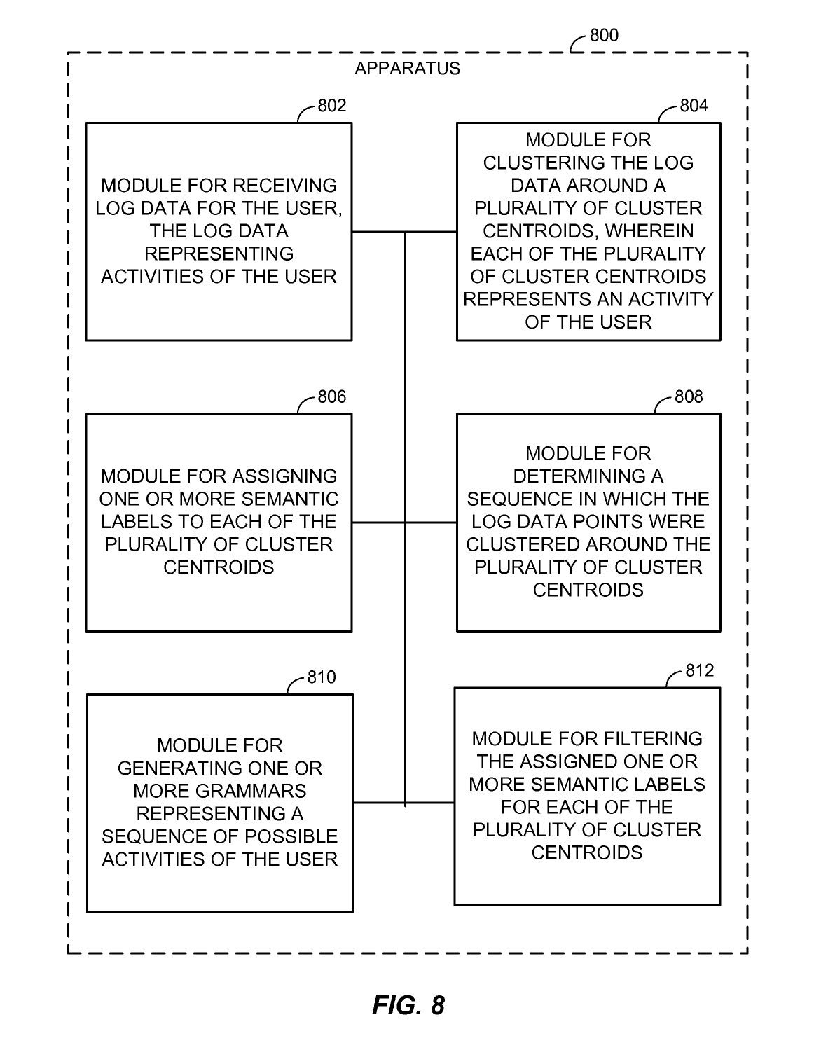

FIG. 8 illustrates an example apparatus 800 represented as a series of interrelated functional modules. A module for receiving 802 may correspond at least in some aspects to, for example, a communication device, such as WAN transceiver 204, LAN transceiver 206, network access ports 404, or a processing system, such as processor 210 or processor 401, in conjunction with a grammar generator module, such as grammar generator module 230, as discussed herein. A module for clustering 804 may correspond at least in some aspects to, for example, a processing system, such as processor 210 or processor 401, in conjunction with a grammar generator module, such as grammar generator module 230, as discussed herein. A module for assigning 806 may correspond at least in some aspects to, for example, a processing system, such as processor 210 or processor 401, in conjunction with a grammar generator module, such as grammar generator module 230, as discussed herein. A module for determining 808 may correspond at least in some aspects to, for example, a processing system, such as processor 210 or processor 401, in conjunction with a grammar generator module, such as grammar generator module 230, as discussed herein. A module for generating 810 may correspond at least in some aspects to, for example, a processing system, such as processor 210 or processor 401, in conjunction with a grammar generator module, such as grammar generator module 230, as discussed herein. A module for filtering 812 may correspond at least in some aspects to, for example, a processing system, such as processor 210 or processor 401, in conjunction with a grammar generator module, such as grammar generator module 230, as discussed herein.

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of generating a grammar describing activities of a user, comprising:
receiving log data for the user, the log data representing activities of the user;
clustering the log data around a plurality of cluster centroids, wherein each of the plurality of cluster centroids represents an activity of the user;
assigning one or more semantic labels to each of the plurality of cluster centroids based on determining that a threshold number of log data points have been assigned to each of the plurality of cluster centroids;
determining a sequence in which the log data points were clustered around the plurality of cluster centroids;
generating one or more grammars representing a sequence of possible activities of the user based on the sequence in which the log data points were clustered around the plurality of cluster centroids and the one or more semantic labels of each of the plurality of cluster centroids; and
filtering the one or more semantic labels for each of the plurality of cluster centroids to generate filtered semantic labels.

2. The method of claim 1, wherein the one or more grammars represent permutations of the one or more semantic labels for each of the plurality of cluster centroids and the sequence in which the log data points were assigned to the plurality of cluster centroids.

3. The method of claim 1, wherein the generating the one or more grammars further comprises:
identifying one or more patterns in the sequence in which the log data points were clustered around the plurality of cluster centroids, wherein each of the one or more patterns comprises a series of cluster centroids of the plurality of cluster centroids; and
assigning one of the one or more semantic labels to each cluster centroid in the one or more patterns.

4. The method of claim 1, wherein the filtering comprises:
comparing a pattern identified in a first grammar of the one or more grammars to a pattern identified in a second grammar of the one or more grammars; and
removing at least one semantic label from the one or more semantic labels based on identifying an overlapping or similar pattern in the first grammar and the second grammar.

5. The method of claim 1, wherein the filtering comprises:
comparing a pattern identified in a first grammar of the one or more grammars to a pattern identified in a second grammar of the one or more grammars; and
assigning a semantic label to at least one cluster centroid in the pattern identified in the second grammar based on a similarity between the first grammar and the second grammar.

6. The method of claim 1, wherein the one or more grammars are generated based on log data received over a period of days.

7. The method of claim 1, wherein the log data comprises global positioning system (GPS) coordinates of the user, phone calls, short message service (SMS)/multimedia messaging service (MMS) messages, and/or emails made and/or received by the user, access to local wireless networks by the user, and/or Internet browsing history of the user.

8. The method of claim 1, wherein an activity of the user comprises a location of the user, a phone call, SMS/MMS message, and/or email sent to and/or received by the user from a particular contact, an access to a local wireless network by the user, and/or an access to a website.

9. The method of claim 1, further comprising:
sending the one or more grammars, the one or more semantic labels, and/or the filtered semantic labels to another device over a wireless network.

10. The method of claim 9, wherein the sending is performed by a user device generating the one or more grammars, and wherein the other device comprises a server or another user device.

11. The method of claim 9, wherein the sending is performed by a server generating the one or more grammars, and wherein the other device comprises another server or a user device.

12. An apparatus for generating a grammar describing activities of a user, comprising:
a processor configured to:
receive log data for the user, the log data representing activities of the user;
cluster the log data around a plurality of cluster centroids, each of the plurality of cluster centroids representing an activity of the user;
assign one or more semantic labels to each of the plurality of cluster centroids based on a determination that a threshold number of log data points have been assigned to each of the plurality of cluster centroids;
determine a sequence in which the log data points were clustered around the plurality of cluster centroids;
generate one or more grammars representing a sequence of possible activities of the user based on the sequence in which the log data points were clustered around the plurality of cluster centroids and the one or more semantic labels of each of the plurality of cluster centroids; and
filter the one or more semantic labels for each of the plurality of cluster centroids to generate filtered semantic labels.

13. The apparatus of claim 12, wherein the one or more grammars represent permutations of the one or more semantic labels for each of the plurality of cluster centroids and the sequence in which the log data points were assigned to the plurality of cluster centroids.

14. The apparatus of claim 12, wherein the processor being configured to generate the one or more grammars comprises the processor being configured to:
identify one or more patterns in the sequence in which the log data points were clustered around the plurality of cluster centroids, wherein each of the one or more patterns comprises a series of cluster centroids of the plurality of cluster centroids; and
assign one of the one or more semantic labels to each cluster centroid in the one or more patterns.

15. The apparatus of claim 12, wherein the processor being configured to filter comprises the processor being configured to:
compare a pattern identified in a first grammar of the one or more grammars to a pattern identified in a second grammar of the one or more grammars; and
remove at least one semantic label from the one or more semantic labels based on an identification of an overlapping or similar pattern in the first grammar and the second grammar.

16. The apparatus of claim 12, wherein the processor being configured to filter comprises the processor being configured to:
compare a pattern identified in a first grammar of the one or more grammars to a pattern identified in a second grammar of the one or more grammars; and
assign a semantic label to at least one cluster centroid in the pattern identified in the second grammar based on a similarity between the first grammar and the second grammar.

17. The apparatus of claim 12, wherein the one or more grammars are generated based on log data received over a period of days.

18. The apparatus of claim 12, wherein the log data comprises global positioning system (GPS) coordinates of the user, phone calls, short message service (SMS)/multimedia messaging service (MMS) messages, and/or emails made and/or received by the user, access to local wireless networks by the user, and/or Internet browsing history of the user.

19. The apparatus of claim 12, wherein an activity of the user comprises a location of the user, a phone call, SMS/MMS message, and/or email sent to and/or received by the user from a particular contact, an access to a local wireless network by the user, and/or an access to a website.

20. The apparatus of claim 12, wherein the apparatus further comprises:
a transceiver configured to send the one or more grammars, the one or more semantic labels, and/or the filtered semantic labels to another device over a wireless network.

21. The apparatus of claim 20, wherein the apparatus comprises a user device, and wherein the other device comprises a server or another user device.

22. The apparatus of claim 20, wherein the apparatus comprises a server, and wherein the other device comprises another server or a user device.

23. An apparatus for generating a grammar describing activities of a user, comprising:
means for receiving log data for the user, the log data representing activities of the user;
means for clustering the log data around a plurality of cluster centroids, wherein each of the plurality of cluster centroids represents an activity of the user;
means for assigning one or more semantic labels to each of the plurality of cluster centroids based on determining that a threshold number of log data points have been assigned to each of the plurality of cluster centroids;
means for determining a sequence in which the log data points were clustered around the plurality of cluster centroids;
means for generating one or more grammars representing a sequence of possible activities of the user based on the sequence in which the log data points were clustered around the plurality of cluster centroids and the one or more semantic labels of each of the plurality of cluster centroids; and
means for filtering the one or more semantic labels for each of the plurality of cluster centroids to generate filtered semantic labels.

24. The apparatus of claim 23, wherein the one or more grammars represent permutations of the one or more semantic labels for each of the plurality of cluster centroids and the sequence in which the log data points were assigned to the plurality of cluster centroids.

25. The apparatus of claim 23, wherein the one or more grammars are generated based on log data received over a period of days.

26. The apparatus of claim 23, wherein the log data comprises global positioning system (GPS) coordinates of the user, phone calls, short message service (SMS)/multimedia messaging service (MMS) messages, and/or emails made and/or received by the user, access to local wireless networks by the user, and/or Internet browsing history of the user.

27. The apparatus of claim 23, wherein an activity of the user comprises a location of the user, a phone call, SMS/MMS message, and/or email sent to and/or received by the user from a particular contact, an access to a local wireless network by the user, and/or an access to a website.

28. The apparatus of claim 1, further comprising:
means for sending the one or more grammars, the one or more semantic labels, and/or the filtered semantic labels to another device over a wireless network.

29. A non-transitory computer-readable medium for generating a grammar describing activities of a user, comprising:
at least one instruction for receiving log data for the user, the log data representing activities of the user;
at least one instruction for clustering the log data around a plurality of cluster centroids, wherein each of the plurality of cluster centroids represents an activity of the user;
at least one instruction for assigning one or more semantic labels to each of the plurality of cluster centroids based on determining that a threshold number of log data points have been assigned to each of the plurality of cluster centroids;
at least one instruction for determining a sequence in which the log data points were clustered around the plurality of cluster centroids;
at least one instruction for generating one or more grammars representing a sequence of possible activities of the user based on the sequence in which the log data points were clustered around the plurality of cluster centroids and the one or more semantic labels of each of the plurality of cluster centroids; and
at least one instruction for filtering the one or more semantic labels for each of the plurality of cluster centroids to generate filtered semantic labels.

30. The non-transitory computer-readable medium of claim 29, wherein the one or more grammars represent permutations of the one or more semantic labels for each of the plurality of cluster centroids and the sequence in which the log data points were assigned to the plurality of cluster centroids.
